(19) United States
(12) Patent Application Publication
(10) Pub. No.: US 2015/0033091 A1
(43) Pub. Date: Jan. 29, 2015

(54) APPARATUS AND METHOD FOR REQUESTING RETRANSMISSION OF LOST PACKET BASED ON MPEG MEDIA TRANSPORT SYSTEM

(71) Applicant: Electronics and Telecommunications Research Institute, Daejeon (KR)

(72) Inventors: Chang-Ki KIM, Daejeon (KR); Jeong-Ju YOO, Daejeon (KR); Jin-Woo HONG, Daejeon (KR)

(21) Appl. No.: 14/339,178

(22) Filed: Jul. 23, 2014

(30) Foreign Application Priority Data
Jul. 23, 2013 (KR) 10-2013-0086944
Apr. 3, 2014 (KR) 10-2014-0040189

(51) Int. Cl. H04L 1/18; H04L 1/08

(52) U.S. Cl. CPC H04L 1/18; H04L 1/08
USPC 714/750

(57) ABSTRACT

An apparatus for requesting retransmission of a lost packet, based on MPEG media transport (MTT) system, may include a packet receiver configured to receive an MPEG media transport (MMT) packet stream from an MMT sending entity; a message generator configured to generate an automatic repeat request (ARQ) feedback (AF) signaling message that includes a packet identifier (ID) that has been assigned to a lost packet; and a message sender configured to transmit the generated AF signaling message to the MMT sending entity.

### CROSS-REFERENCE TO RELATED APPLICATION(S)

This application claims priority from Korean Patent Application No. 10-2013-0086944, filed on Jul. 23, 2013, and 10-2014-0040189, filed on Apr. 3, 2014, in the Korean Intellectual Property Office, the disclosures of which are incorporated herein by references in its entirety.

### BACKGROUND

1. Field

The following description relates to a media transport service based on an MPEG media transport (MMT) system, and more particularly, to an efficient automatic repeat request (ARQ) process.

2. Description of the Related Art

MPEG media transport (MMT) is a standard under development by ISO/IEC WG11 system sub-working group of Moving Picture Experts Group (MPEG) since 2010. FIG. 1 is a diagram illustrating a protocol stack including functional areas of an MMT system in conformity with MPEG ISO/IEC DIS 23008-1 standard specifications. The protocol stacks largely include four functional areas including Encapsulation Functional Area, Signaling Functional Area, Composition Functional Area, and the like.

As MMT standard specifications, standardization of automatic repeat request (ARQ) is additionally under development through a separate amendment document titled “ISO/IEC 23008-1 AMD Additional technologies for MMT.” In this amendment document, two signaling messages are defined: one is an ARQ configuration (AC) signaling message for delivering ARQ policies, time-to-live of retransmitted packet, etc. for MMT ARQ from an MMT sending entity to an MMT receiving entity, and the other is an ARQ Feedback (AF) signaling message that is transmitted from the MMT receiving entity that has detected lost packets to the MMT sending entity so as to request the MMT sending entity to retransmit the lost packets.

FIG. 2 is a diagram illustrating basic MMT ARQ process specified by MMT amendment specifications. First, an MMT sending entity transmits information about ARQ policies and others to an MMT receiving entity using an AC signaling message. Then, the MMT receiving entity programs the settings based on the received setting information. The MMT receiving entity detects packet loss in the MMT packets received from the MMT sending entity (MMT standardization does not cover packet loss detection), extracts flow_label and sequence number information of the lost packets, and transmits the extracted information to the MMT sending entity using an AF signaling message. Finally, the MMT sending entity that has received the AF signaling message retransmits the lost is MMT packets with reference to the flow label and sequence numbers.

The MMT sending entity transmits MMT payload data that includes MMT packet header. The MMT payload may be traffic data, signaling data, file, and the like. The MMT payload header and the MMT packet header format are specified by MMT specifications. The AC signaling message and the AF signaling message may be included in the MMT payload of MMT packets, and then the MMT packets are sent and received.

FIG. 3 is a diagram illustrating a format of an AF signaling message used in ARQ process for request for retransmitting lost packets. Common headers of MMT signaling messages include “message_id,” “version,” and “length” , and “message_payload” essentially includes bit mask information that indicates flow label, “packet_sequence_number,” and sequence numbers of lost packets. According to the definition of MMT packet header field of standard specifications, flow is a bit stream or a group of bit streams of resources reserved by asset delivery characteristics (ADC), and different labels are distinguished by flow labels. “Packet_sequecne_number” is a 32-bit integer value that sequentially increases within a single packet ID. In the MMT receiving entity, the sequence numbers of the received packets are managed according to packet ID.

As shown in FIG. 3, the AF signaling message used to alert the information of lost packets is basically generated based on flow label. In other words, when detecting packet loss in one of the received packet stream, the MMT receiving entity generates an AF signaling message based on flow label of the corresponding packet stream, in which packet loss has been detected, and sequence numbers and bit mask of the lost packets, and then the MMT receiving entity transmits the generated AF signaling message to the MMT sending entity. According to the existing MMT ARQ scheme, for error recovery by the MMT receiving entity using AR, flow label must be found in a received packet stream. The Flow label field in MMT packet header, however, is an optional field according to the existing MMT specifications. If an MMT sending entity transmits an MMT packet stream, which contains payload (media), without flow label, the MMT receiving entity cannot generate an accurate AF signaling message without knowing the flow label. Therefore, normal ARQ process cannot be properly performed.

As shown in FIG. 3, the current AF signaling message has a flow label and a sequence number, which is a number that is assigned for each packet ID. Therefore, generating an AF signal message based on flow label and sequence number is possible only when flow label and packet ID uniquely match each other in a manner that is 1:1. However, due to ADC and the transmission characteristics of the MMT sending entity, packet streams with different packet IDs may have the same flow label. In this case, during the flow label-based ARQ process, sequence number may be included when generating an AF signaling message. However, the MMT sending entity that has received the AF signaling message cannot identify a packet stream in which packet loss has occurred from among all packet streams with the same flow label, and thus fails in error recovery.

In conclusion, in the existing MMT ARQ process, ARQ is performed based on flow label, so that when MMT packets transmitted from an MMT sending entity to an MMT receiving entity does not include flow label, it is not possible to perform ARQ process for lost packets. Also, when packet loss has occurred in different packet streams with the same flow label, it is not possible to perform error recovery through MMT ARQ.

### SUMMARY

In one general aspect, there is provided An apparatus for requesting retransmission of lost packets based on a Moving Picture Experts Group (MPEG) media transport system, the apparatus including: a packet receiver configured to receive an MPEG media transport (MMT) packet stream from an MMT sending entity; a message generator configured to generate an automatic repeat request (ARQ) feedback (AF) signaling message that includes a packet identifier (ID) that has been assigned to a lost packet; and a message sender configured to transmit the generated AF signaling message to the MMT sending entity.

The AF signaling message may include different packet IDs. The message generator may generate an AF signaling message by including flow label that is contained in MMT packet header of an MMT packet stream in which packet loss has occurred.

The AF signaling message may include different packet IDs associated with the same flow label.

In another general aspect, there is provided a method for requesting retransmission of a lost packet, based on an MPEG media transport system, the method including: receiving an ARQ configuration (AC) message from an MPEG media transport (MTT) sending entity and setting an ARQ; receiving an MMT packet stream from the MMT sending entity; checking whether a packet is lost in the received MMT packet stream; in response to a lost packet being identified by the checking, generating an AF signaling message to request retransmission of the lost packet, the generated signaling message including a packet ID which has been assigned to the lost packet; and transmitting the generated AF signaling message to the MMT sending entity.

The checking may include classifying MMT packets of the received packet stream by packet ID and storing the classified MMT packets in a receiving buffer, and detecting packet loss by checking the receiving buffer.

The generating of the AF signaling message may include, if flow label is included in MMT packet header of an MMT packet stream in which packet loss has occurred, generating the AF signaling message by including the flow label in the message.

The AF signaling message may include different packet IDs associated with the same flow label.

Other features and aspects will be apparent from the following detailed description, the drawings, and the claims.

### BRIEF DESCRIPTION OF THE DRAWINGS

FIG. 1 is a diagram illustrating a protocol stack including functional areas of an MMT system in conformity with MPEG ISO/IEC DIS 23008-1 standard specifications.

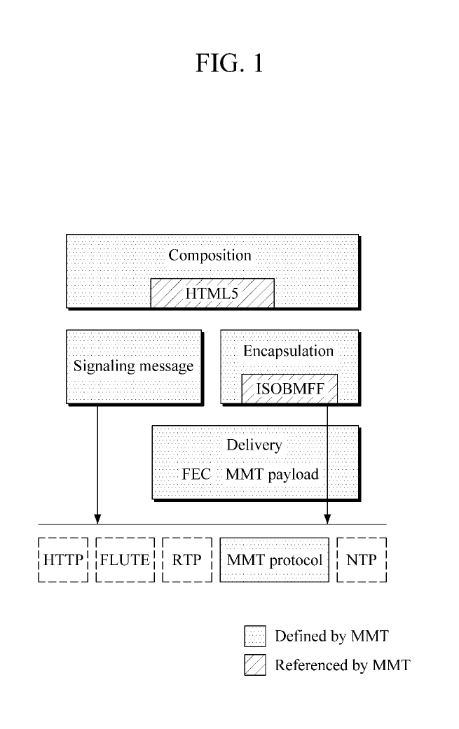

FIG. 2 is a diagram illustrating basic MPEG media transport (MMT) Automatic Repeat request (ARQ) process specified by MMT amendment specifications.

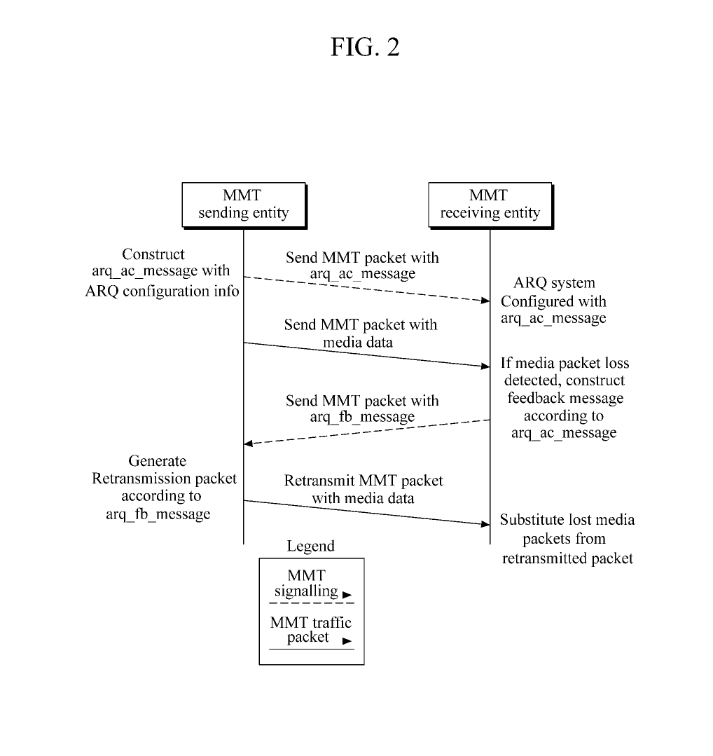

FIG. 3 is a diagram illustrating a format of an AF signaling message used in ARQ process for requests for retransmitting lost packets.

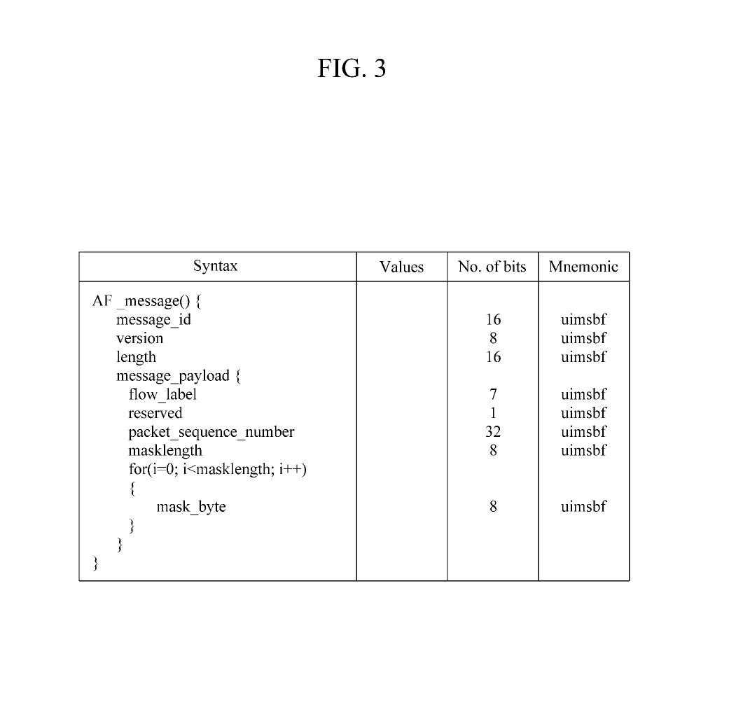

FIG. 4 is a diagram illustrating a format structure of an MPEG ARQ feedback (AF) signaling message according to an exemplary embodiment.

FIG. 5 is a diagram illustrating a format structure of an MMT AF signaling message according to another exemplary embodiment.

FIG. 6 is a block diagram illustrating an apparatus for requesting retransmission of packets according to an exemplary embodiment.

FIG. 7 is a flowchart illustrating a method of requesting retransmission of a packet according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

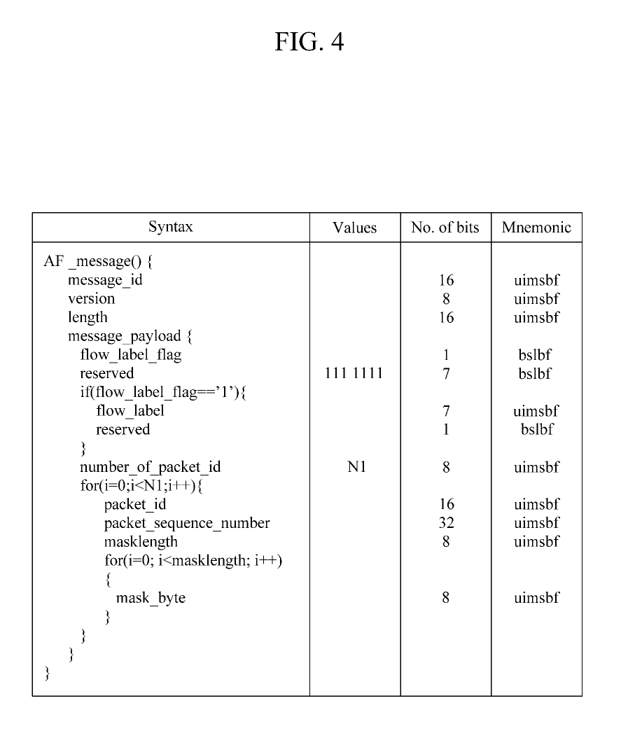

FIG. 4 is a diagram illustrating a format structure of an MPEG media transport (MMT) Automatic Repeat request (ARQ) feedback (AF) signaling message according to an exemplary embodiment. The format shown in FIG. 4 is suggested to solve the existing problems, and presents syntax of an AF signaling message containing packet identifier (ID) information. The MMT AF signaling message consists of three signaling message common headers, two reserved fields, and further seven fields. Semantics of each of the seven fields are as follows:

(1) flow_label_flag: this field is a flag that indicates the presence of flow label in the AF signaling message, and is set to “1” if a stream (based on packet ID) identified as having packet loss, among packets received from an MMT sending entity, includes flow label.

(2) flow_label: this field is valid only when “flow_label_flag” of the packet stream (based on packet ID) in which packets are lost has been set.

(3) number_of_packet_id: this field indicates the number of ARQs, i.e., packet IDs to be retransmitted, and in the presence of flow label, the number indicated by this field is equal to or smaller than the maximum number of packet IDs with the same flow label.

(4) packet_id: this field is a packet ID included in MMT header, indicating a packet ID value of a detected packet stream in which a packet loss has occurred. In the presence of flow label, the packet_id value in this field includes packet id_values related to the flow label.

(5) packet_sequence_number: this field indicates a sequence number of the first lost packet among the packet stream with a corresponding packet id.

(6) mask_length: this field indicates the number of masks (in bytes) for indicating the sequence number of the lost packet.

(7) mask_byte: Each bit represents a lost sequence number of a corresponding packet id (masked to “1”), and the first bit of the first byte indicates the first lost packet among the received packets.

As shown in FIG. 4, for the effective MMT ARQ, the AF signaling message includes one flow label (if used) and multiple packet IDs associated with the flow label. Here, the multiple packet IDs may be packet identifiers that have the same flow label. Accordingly, when flow label is not known, ARQ based on packet ID may be performed, and ARQ based on flow label may be performed with respect to different packet streams with the same flow label. Additionally, in the aforementioned two cases, it is possible to include packet loss information with respect to the multiple packet IDs in the AF signaling message. Further, the ARQ process may be enabled to be performed not only based on single flow label, but also based on multiple flow labels.

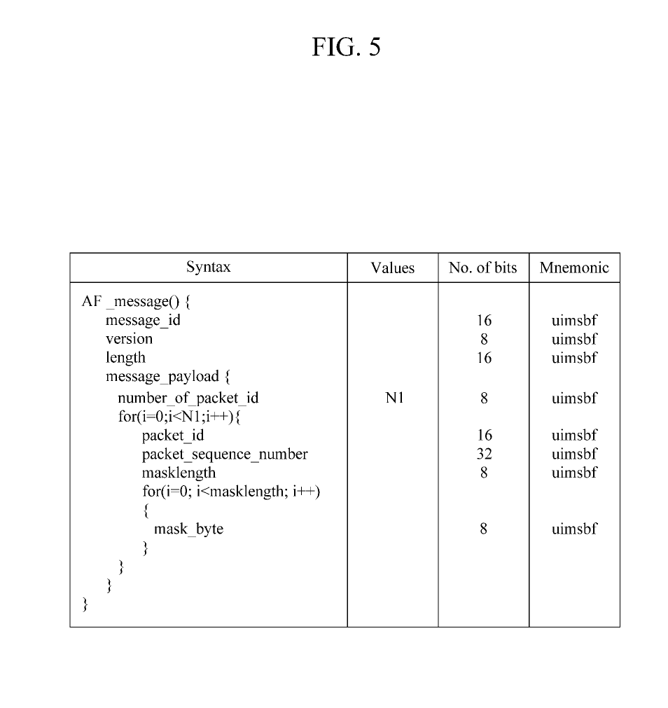

FIG. 5 is a diagram illustrating a format structure of an MMT AF signaling message according to another exemplary embodiment. The format structure shown in FIG. 5 does not include flow label flag field or flow label field of a message payload shown in the format structure in FIG. 4, which is the only difference between the two formats, and the other elements are the same. Even without these two fields, it is still possible to perform ARQ based on packet ID. Practically, the format structure shown in FIG. 5 is the same as the format structure shown in FIG. 4 of the case in which flow label is not known.

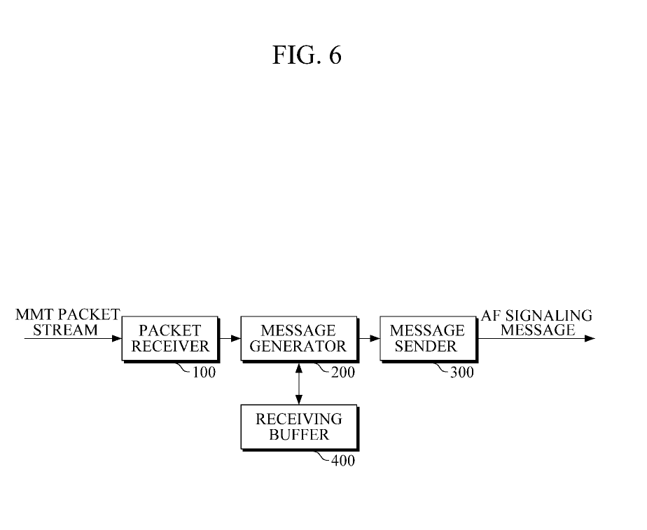

FIG. 6 is a block diagram illustrating an apparatus for requesting retransmission of packets according to an exemplary embodiment. The apparatus shown in FIG. 6 is included in an MMT receiving entity. The apparatus includes a packet receiver 100, a message generator 200, and a message sender 300. The apparatus may further include a receiving buffer 400, which may include a plurality of buffers. The packet receiver 100 receives an MMT packet stream from an MMT sending entity. The message generator 200 may be implemented in a “hardware” manner as a processor, and may generate an AF signaling message in the presence of a lost packet in the received MMT packet stream. In one example, the message generator 200 may parse MMT packet header and payload header of the received MMT packet stream, and store the MMT packets in the receiving buffer 400 by flow label and packet ID associated with the flow label. In a case where there is no flow label, the message generator 200 may store the MMT packets in the receiving buffer 400 by flow label or associated packet ID. The message generator 200 may check the receiving buffer 400, either immediately or on a regular basis, to monitor packet loss. If packet loss is detected, subsequent procedures will vary depending on whether or not the packet stream in which the packet loss has occurred includes flow label. In a case where the packet stream includes flow label, the message generator 200 generates an AF signaling message that contains the flow label, packet IDs associated with the flow label, and the lost sequence numbers. In a case where the packet stream does not include the flow label, the message generator 200 may generate an AF signaling message that contains packet IDs and the lost sequence numbers. In this case, since flow label does not exist, it is apparent that the AF signaling message does not include the flow label. The message sender 300 transmits the generated AF signaling message to the MMT sending entity.

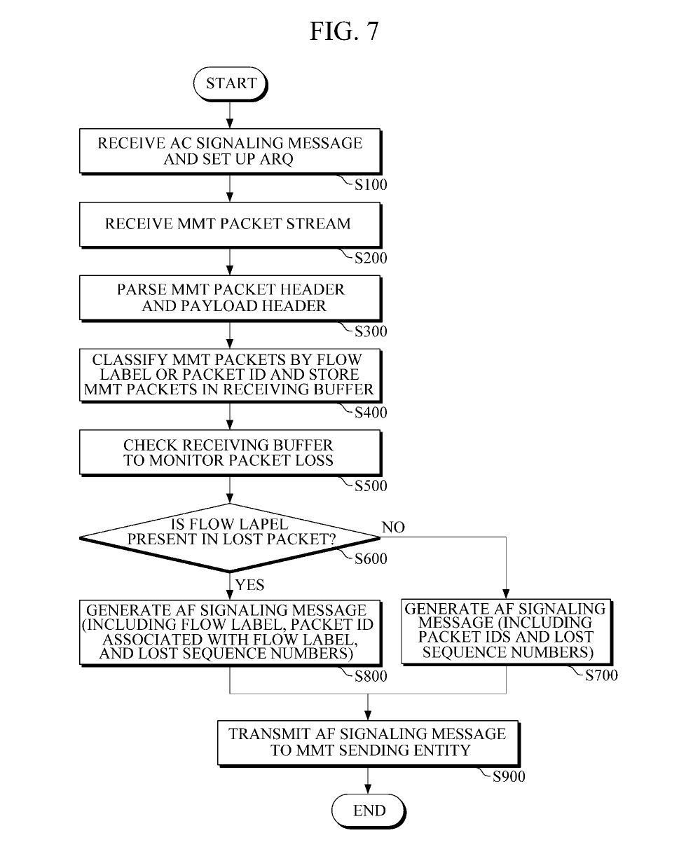

FIG. 7 is a flowchart illustrating a method for requesting retransmission of a packet according to an exemplary embodiment. This method is a more effective ARQ process performed in an MMT receiving entity. The MMT receiving entity receives an AC signaling message from an MMT sending entity and sets up an ARQ in S100. Then, the MMT receiving entity receives an MMT packet stream from the MMT sending entity in S200, and parses MMT packet header and payload header of the received MMT packet stream in S300. Then, in S400, the MMT receiving entity stores the parsed MMT packet header and payload header in a receiving buffer by flow label or packet ID. Then, the MMT receiving entity checks the receiving buffer immediately or on a regular basis to monitor packet loss in S500. In response to detecting packet loss, the MMT receiving entity determines in S600 whether or not the packet stream in which the packet loss has occurred includes flow label.

In response to a determination that the packet stream does not include flow label, the MMT receiving entity sets flow_label_flag field to “false,” generates a bit mask for sequence numbers associated with packet IDs of lost packets, and generates packet loss information related to multiple packet IDs into a single AF signaling message in S700. Then, the MMT receiving entity transmits the generated AF signaling message to the MMT sending entity in S900. In response to a determination that the packet stream includes flow label, the MMT receiving entity sets flow_label_flag field to “true” and generates an AF signaling message that contains the flow label, the number of packet IDs of lost packets among packet IDs having the flow label, associated packet IDs, and bit mask indicators related to lost sequence numbers of the relevant packet IDs in S800. Then, the MMT receiving entity transmits the generated AF signaling message to the MMT sending entity in S900.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for requesting retransmission of lost packets based on a Moving Picture Experts Group (MPEG) media transport system, the apparatus comprising:
a packet receiver configured to receive an MPEG media transport (MMT) packet stream from an MMT sending entity;
a message generator configured to generate an automatic repeat request (ARQ) feedback (AF) signaling message that includes a packet identifier (ID) that has been assigned to a lost packet; and
a message sender configured to transmit the generated AF signaling message to the MMT sending entity.

2. The apparatus of claim 1, wherein the AF signaling message includes different packet IDs.

3. The apparatus of claim 1, wherein the message generator generates an AF signaling message by including flow label that is contained in MMT packet header of an MMT packet stream in which packet loss has occurred.

4. The apparatus of claim 3, wherein the AF signaling message includes different packet IDs associated with the same flow label.

5. A method for requesting retransmission of a lost packet, based on an MPEG media transport system, the method comprising:
receiving an ARQ configuration (AC) message from an MPEG media transport (MTT) sending entity and setting an ARQ;
receiving an MMT packet stream from the MMT sending entity;
checking whether a packet is lost in the received MMT packet stream;
in response to a lost packet being identified by the checking, generating an AF signaling message to request retransmission of the lost packet, the generated signaling message including a packet ID which has been assigned to the lost packet; and
transmitting the generated AF signaling message to the MMT sending entity.

6. The method of claim 5, wherein the checking comprises classifying MMT packets of the received packet stream by packet ID and storing the classified MMT packets in a receiving buffer, and detecting packet loss by checking the receiving buffer.

7. The method of claim 5, wherein the generating of the AF signaling message comprises, if flow label is included in MMT packet header of an MMT packet stream in which packet loss has occurred, generating the AF signaling message by including the flow label in the message.

8. The method of claim 7, wherein the AF signaling message includes different packet IDs associated with the same flow label.
